(19) United States
(12) Patent Application Publication
(10) Pub. No.: US 2026/0201924 A1
(43) Pub. Date: Jul. 16, 2026

(54) AIRFOIL BEARING

(71) Applicant: Hanon Systems, Daejeon (KR)

(72) Inventors: Jun Hyuk PARK, Daejeon (KR); Chi Yong PARK, Daejeon (KR); Hyun Sup YANG, Daejeon (KR); Jong Sung LEE, Daejeon (KR); Kyu Sung CHOI, Daejeon (KR)

(73) Assignee: Hanon Systems, Daejeon (KR)

(21) Appl. No.: 19/135,067

(22) PCT Filed: Oct. 12, 2023
(86) PCT No.: PCT/KR2023/015706

§ 371 Date: Jun. 2, 2025

(30) Foreign Application Priority Data
Dec. 7, 2022 (KR) 10-2022-0169240

(51) Int. Cl. F16C 17/02; F16C 35/02

(52) U.S. Cl. CPC F16C 17/024; F16C 35/02

(57) ABSTRACT

The present invention relates to an airfoil bearing applied for an ultra-high speed operation of a rotating apparatus, and more particularly, to an airfoil bearing having a structure in which a bump foil key at one end of a bump foil and a bump foil key at the other end of the bump foil are formed asymmetrically, which may improve driving performance and durability performance against disturbance.

### TECHNICAL FIELD

The present invention relates to an airfoil bearing applied for an ultra-high speed operation of a rotating apparatus, and more particularly, to an airfoil bearing having a structure in which a bump foil key at one end of a bump foil and a bump foil key at the other end of the bump foil are formed asymmetrically, which may improve driving performance and durability performance against disturbance.

### BACKGROUND ART

Typically, a fuel cell electric vehicle includes a fuel cell stack configured to produce electricity, a humidifier configured to increase a humidity of air to be supplied to the fuel cell stack, a fuel supply part configured to supply hydrogen to the fuel cell stack, an air supply part configured to supply air, which contains oxygen, to the fuel cell stack, and a cooling module configured to cool the fuel cell stack.

The air supply part includes an air cleaner configured to filter out foreign substances contained in the air, an air compressor configured to compress and supply the air filtered by the air cleaner, a cooling device configured to cool the compressed high-temperature air, a humidifier configured to increase a humidity of the air, and a valve configured to adjust a flow rate.

The air compressor compresses the air, which is sucked from the outside, by using a compressor impeller and transfers the air to the fuel cell stack. In this case, the compressor impeller is connected to a rotary shaft that receives power from a drive part. In general, the drive part operates the rotary shaft by means of electromagnetic induction between a stator and the rotary shaft. In this case, the air compressor has an air foil bearing to allow the rotary shaft to rotate easily at high speed.

A bearing refers to a mechanical element that fixes a rotary shaft to a predetermined position, supports a weight of the shaft and a load applied to the shaft, and allows the shaft to rotate. An airfoil bearing refers to a bearing in which air, which is a fluid having a viscosity, is introduced between foils, which adjoins a rotor or a bearing disc, and generates pressure as the rotor (or a rotary shaft) rotates at a high speed, thereby supporting a load. Among the airfoil bearings, an airfoil journal bearing refers to a bearing configured to support a load of a rotor in a radial direction that is a direction perpendicular to the rotor.

FIG. 1 is a view illustrating a cross-section of an airfoil journal bearing in the related art. The airfoil journal bearing is configured such that a bump foil 20 is installed along a circumferential inner surface 12 of a hollow portion 11 of a bearing housing 10, a top foil 30 is disposed inside the bump foil 20, and a rotor 40 (or rotary shaft) is disposed inside the top foil 30, such that the rotor may rotate in a state in which an inner peripheral surface of the top foil 30 and an outer peripheral surface of the rotor 40 are spaced apart from each other.

In this case, the bump foil 20 and the top foil 30 respectively have bent portions made as circumferential ends of the bump foil 20 and the top foil 30 are bent radially outward, and the bent portions 21 and 31 are inserted and coupled into a key groove 13 formed in the bearing housing 10, such that the bump foil 20 and the top foil 30 are fixed to the bearing housing 10 without being rotated or pushed in the circumferential direction when the rotor rotates.

The air foil journal bearing in the related art is configured such that both the bent portion 21 of the bump foil 20 and the bent portion 31 of the top foil 30 are fixed into the single key groove 13. In this case, no means for restricting an axial movement of the bump foil 20 is provided at a side of the bump foil 20 opposite to the bent portion 21. For this reason, the side of the bent portion 21, which is opposite to the bump foil 20, may protrude axially outward from the housing 10 when the rotor rotates and come into contact with a rotary shaft, a runner, an impeller, or the like that is adjacent to the bearing, which causes a problem in that the bearing is damaged.

### DOCUMENT OF RELATED ART

(Patent Document 1) Korean Patent Application Laid-Open No. 10-2022-0129786 (published on Sep. 26, 2022)

### DISCLOSURE

### Technical Problem

The present invention has been made in an effort to solve the above-mentioned problem, and an object of the present invention is to provide an airfoil bearing having a structure in which a bump foil key at one end of a bump foil and a bump foil key at the other end of the bump foil are formed asymmetrically, which may improve driving performance and durability performance against disturbance.

### Technical Solution

An airfoil bearing according to one example of the present invention may include: a bearing housing having a cylindrical structure; a top foil disposed to be spaced apart from an inner side of the bearing housing; and a bump foil disposed between the bearing housing and the top foil, in which in an inner peripheral surface of the bearing housing, a top foil key groove, into which a pair of top foil keys formed by bending two opposite ends of the top foil radially outward are inserted, is formed, and a bump foil key groove, into which a pair of bump foil keys formed by bending two opposite ends of the bump foil radially outward are inserted, is formed, and in which when any one of the pair of bump foil keys is referred to as a first bump foil key and the remaining one of the pair of bump foil keys is referred to as a second bump foil key, the first bump foil key and the second bump foil key are formed asymmetrically.

The first bump foil key may be fixed and tightly attached to an inner wall of the bump foil key groove, and the second bump foil key may be disposed to be spaced apart from the inner wall of the bump foil key groove at a predetermined interval.

The first bump foil key may be formed to be longer than the second bump foil key, and the first bump foil key may have a structure bent at least one or more times.

The first bump foil key may have a structure in which a vertical portion, which is formed in an ‘L’ shape bent in a circumferential direction and disposed in a radial direction, and a horizontal portion, which extends in the circumferential direction from a lower end of the vertical portion, are connected, and the vertical portion may be tightly attached to the inner wall of the bump foil key groove.

A length of the vertical portion may be equal to a depth of the bump foil key groove, and the horizontal portion may be configured to be tightly attached to a bottom of the bump foil key groove.

A length of the horizontal portion may be equal to or smaller than a width of the bottom of the bump foil key groove.

A length of the vertical portion may be smaller than a depth of the key groove, and the horizontal portion may be disposed to be spaced apart from a bottom of the bump foil key groove at a predetermined interval.

An angle between the vertical portion and the horizontal portion may be a right angle.

A length of the horizontal portion may be equal to or smaller than a width of the bottom of the bump foil key groove.

An angle between the vertical portion and the horizontal portion may be an obtuse angle or an acute angle.

A length of the horizontal portion may be equal to or larger than a width of the bottom of the bump foil key groove.

The first bump foil key may correspond to an end of a starting side of the bump foil key based on a rotation direction, and the second bump foil key may correspond to an end of an ending side of the bump foil key based on the rotation direction.

When the bump foil has a structure in which two or more bump foil units are stacked and coupled, a bump foil key formed at one end of the bump foil unit positioned at a radially outermost side and a bump foil key formed at the other end of the bump foil unit among the two or more bump foil units may be formed asymmetrically.

An etching portion may be formed on the top foil and has a stepped structure formed at a central portion thereof by being changed in thickness or bent, and the etching portion may be positioned inward of the bump foil key groove in a rotation direction.

### Advantageous Effects

According to the present invention, the bump foil key at one end of the bump foil and the bump foil key at the other end of the bump foil are formed asymmetrically, which may improve driving performance and durability performance against disturbance.

### DESCRIPTION OF DRAWINGS

FIG. 1 is a view illustrating a cross-section of an airfoil journal bearing in the related art.

FIG. 2 is a cross-sectional view of an airfoil bearing according to an example of the present invention.

FIG. 3 is an exploded perspective view illustrating foils.

FIG. 4 is a deployed cross-sectional view of a bump foil in the related art.

FIG. 5 is an enlarged view illustrating a bump foil key groove portion in the related art.

FIG. 6 is a waterfall data graph illustrating a bearing operation in the related art.

FIG. 7 is a deployed cross-sectional view illustrating a bump foil of the present invention.

FIG. 8 is an enlarged view illustrating a bump foil key groove portion of the present invention.

FIG. 9 is a waterfall data graph illustrating a bearing operation of the present invention.

FIG. 10 is a view illustrating FIG. 2 again.

FIGS. 11 to 13 are views illustrating a bump foil structure according to another example of the present invention.

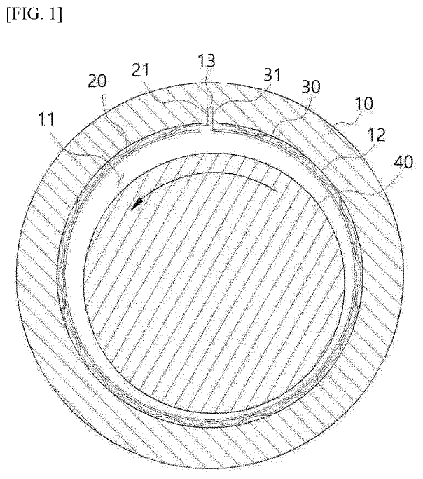

### BEST MODE

Hereinafter, the present invention will be described with reference to the accompanying drawings.

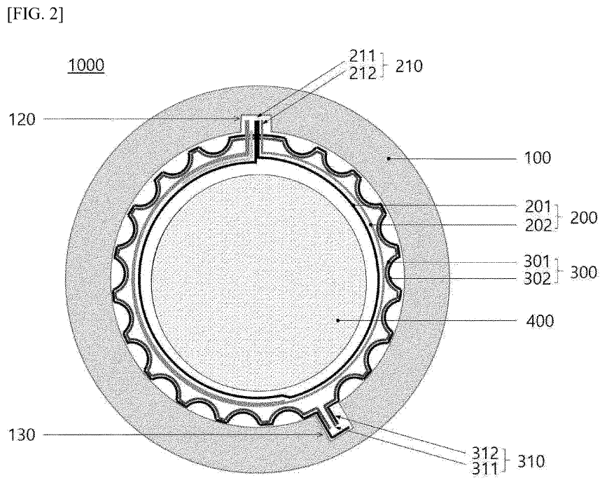

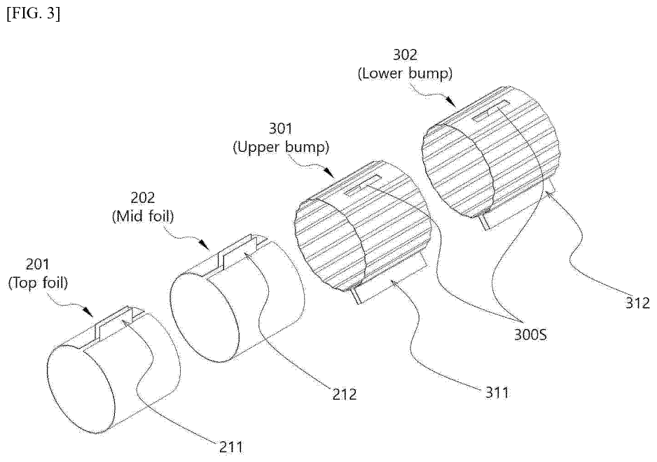

FIG. 2 is a cross-sectional view of an airfoil bearing according to an example of the present invention, and FIG. 3 is an exploded perspective view illustrating foils. As illustrated, an airfoil bearing 1000 of the present invention may broadly include a bearing housing 100, a top foil 200, and a bump foil 300 and accommodate a rotor 400 at a center thereof.

The bearing housing 100 is a structure formed as a cylindrical structure and configured to support and protect the top foil 200 and the bump foil 300 disposed inside the bearing housing, and a top foil key groove 120 and a bump foil key groove 130 having groove structures are formed in an inner peripheral surface of the bearing housing 100. The top foil key groove 120 and the bump foil key groove 130 have groove structures into which a pair of top foil keys 210 formed at two opposite ends of the top foil 200 and a pair of bump foil keys 310 formed at two opposite ends of the bump foil 300, which will be described below, are inserted so that the top foil keys 210 and the bump foil keys 310 are fixed. As described above, the top foil key groove 120 and the bump foil key groove 130 are formed, and the top foil keys 210 and the bump foil keys 310 are fixedly inserted into the top foil key groove 120 and the bump foil key groove 130, such that the axial motions of the top foil 200 and the bump foil 300 may be suppressed.

The top foil 200 is disposed in a circular shape and spaced apart from an inner side of the bearing housing 100 at a predetermined interval. The top foil 200 is a flat plate having a small thickness. With reference to FIGS. 2 and 3, the top foil 200 of the present invention may have a structure in which a first top foil 201 and a second top foil 202 are stacked in a radial direction. In this case, the first top foil 201 positioned radially outward is particularly referred to as a top foil 201, and the second top foil 202 positioned radially inward is also referred to as a mid-foil 202. Meanwhile, although not illustrated, the top foil 200 may have a structure in which many foils are stacked and coupled.

Two opposite ends, i.e., one end and the other end of the top foil 200 are bent radially outward, such that the pair of top foil keys 210 are formed at the two opposite ends of the top foil 200. The top foil key 210 is fixedly inserted into the top foil key groove 120 of the bearing housing 100. The pair of top foil keys 210 may include a pair of top foil keys 211 formed at two opposite ends of the first top foil 201, and a pair of top foil keys 212 formed at two opposite ends of the second top foil 202.

In this case, with reference to FIG. 3, the pair of top foil keys 211 and 212 may have structures that penetrate a slit portion 300S formed in a middle portion of the bump foil 300. This configuration may provide a dual effect of increasing a fixing force between the top foils, i.e., the first top foil 201 and the second top foil 202 and increasing a fixing force of the bump foil 300.

The bump foil 300 is disposed in a circular shape between the bearing housing 100 and the top foil 200. The bump foil 300 is a flat plate having a small thickness. The bump foil 300 may have a plurality of bumps (not illustrated) convexly protruding in the radial direction and spaced apart from one another in the circumferential direction. With reference to FIGS. 2 and 3, the bump foil 300 of the present invention may have a structure in which a first bump foil 301 and a second bump foil 302 are stacked in the radial direction. In this case, the first bump foil 301 positioned radially outward is particularly referred to as an upper bump foil 301, and the second bump foil 302 positioned radially inward is also referred to as a lower bump foil 302. Meanwhile, although not illustrated, the bump foil 300 may have a structure in which many foils, i.e., a plurality of bump foil units are stacked and coupled.

In the present invention, the airfoil bearing having the above-mentioned structure has a structure in which any one of the pair of bump foil keys 310 and the remaining one of the pair of bump foil keys 310 are formed asymmetrically.

More specifically, when any one of the pair of bump foil keys 310 is referred to as a first bump foil key and the remaining one of the pair of bump foil keys 310 is referred to as a second bump foil key, the first bump foil key and the second bump foil key have different lengths, shapes, and coupling types. In this case, in case that the bump foil includes a plurality of bump foil units, the bump foil units positioned at radially outermost sides, i.e., a pair of bump foil keys 312 of the lower bump foil 302 may be formed asymmetrically.

Meanwhile, except for the lower bump foil 302, the upper bump foil 301 is installed to float from the lower bump foil 302, such that two opposite ends of the upper bump foil 301 are formed as free ends. Therefore, unlike the lower bump foil 302, upper bump foil keys 311 at one end and the other end may not be configured asymmetrically. However, the upper bump foil keys at the two opposite ends do not need to be identical to each other. The upper bump foil keys may, of course, be designed and modified as much as needed so that the upper bump foil keys are configured symmetrically or asymmetrically while corresponding to the lower bump foil keys or regardless of the structures of the lower bump foil keys. Therefore, the discussion of the upper bump foil will be omitted.

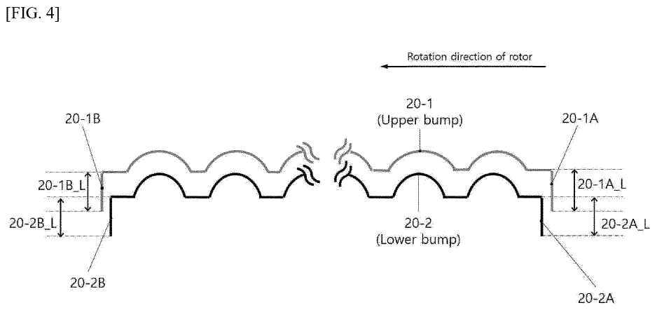

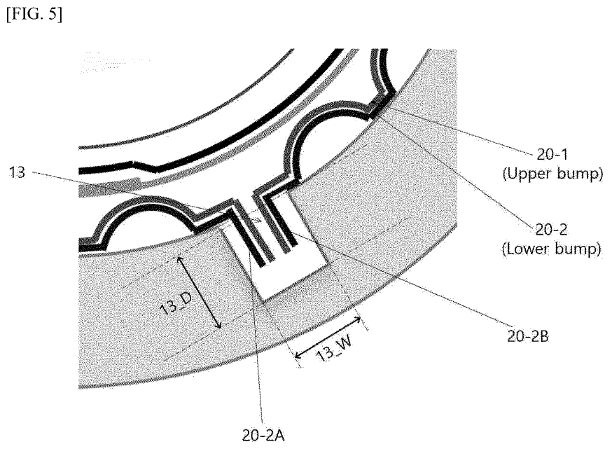

FIG. 4 is a deployed cross-sectional view of a bump foil in the related art, and FIG. 5 is an enlarged view illustrating a bump foil key groove portion in the related art. As illustrated, bump foils 20-1 and 20-2 in the related art are configured such that bump foil keys 20-1A and 20-2A at one end and bump foil keys 20-1B and 20-2B at the other end have the same length and shape. That is, in case that a bump foil 20 includes an upper bump foil 20-1 and a lower bump foil 20-2, a lower bump foil key 20-2A at one end of the lower bump foil 20-2 positioned at a radially outermost side and the lower bump foil key 20-2B at the other end have the same structure.

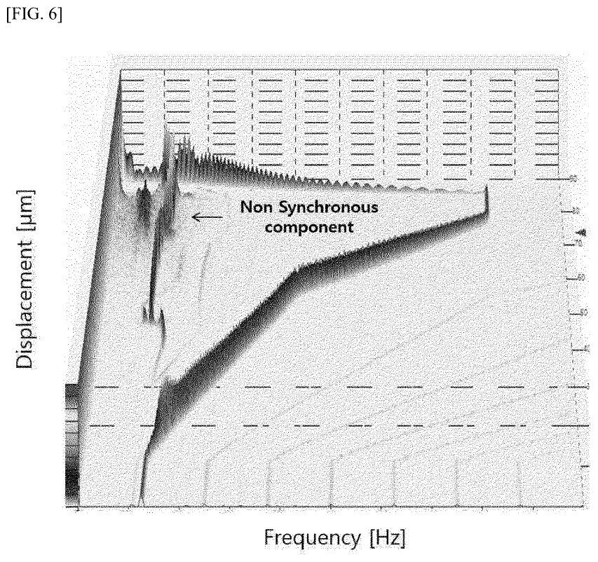

With reference to FIG. 5, the pair of lower bump foil keys 20-2A and 20-2B are inserted into a lower bump foil key groove 13, and two opposite ends thereof are installed as free ends without being fixed. Because the bump foil keys 20-2A and 20-2B are not tightly attached to the bump foil key groove 13 as described above, there is a problem in that a stick-slip phenomenon of the bump foil is maximized, and instability caused by operations and external vibration is increased. FIG. 6 is a waterfall data graph illustrating a bearing operation in the related art. As illustrated, it can be ascertained that asynchronous components occur in an initial frequency region.

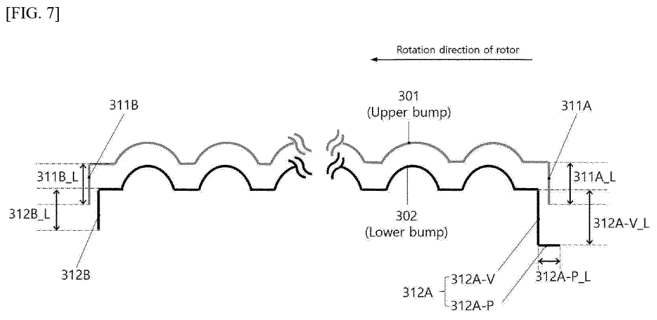

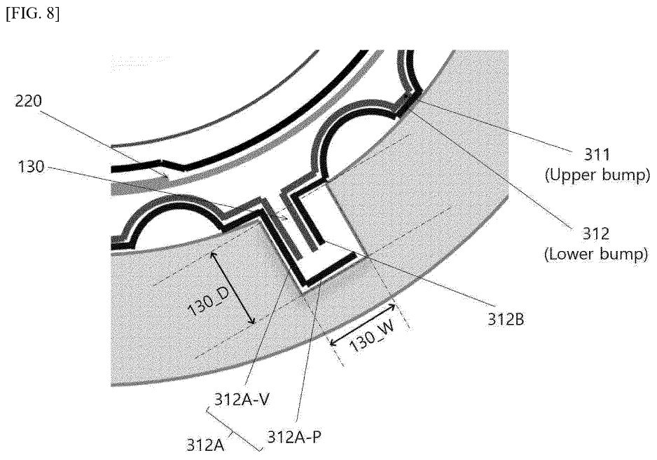

In order to solve the above-mentioned problem, in the present invention, the first bump foil key and the second bump foil key are configured asymmetrically. FIG. 7 is a deployed cross-sectional view illustrating a bump foil of the present invention, and FIG. 8 is an enlarged view illustrating a bump foil key groove portion of the present invention. As described above, the bump foil 300 may include the upper bump foil 301 and the lower bump foil 302. In this case, lower bump foil keys 312A and 312B at the two opposite ends of the lower bump foil 302 positioned at the radially outermost side are configured asymmetrically, such that any one of the pair of bump foil keys 312 of the lower bump foil corresponds to a first bump foil key 312A, and the remaining one of the pair of bump foil keys 312 corresponds to a second bump foil key 312B.

With reference to FIG. 8, the first bump foil key 312A is fixed and tightly attached to an inner wall of the bump foil key groove 130, and the second bump foil key 312B is disposed to be spaced apart from the inner wall of the bump foil key groove 130 at a predetermined interval. That is, the first bump foil key 312A is inserted into the bump foil key groove 130, tightly attached to the bump foil key groove 130, and installed as a fixed end, and the second bump foil key 312B is inserted into the bump foil key groove 130 at a side opposite to the first bump foil key 312A, spaced apart from the bump foil key groove 130, and installed as a free end.

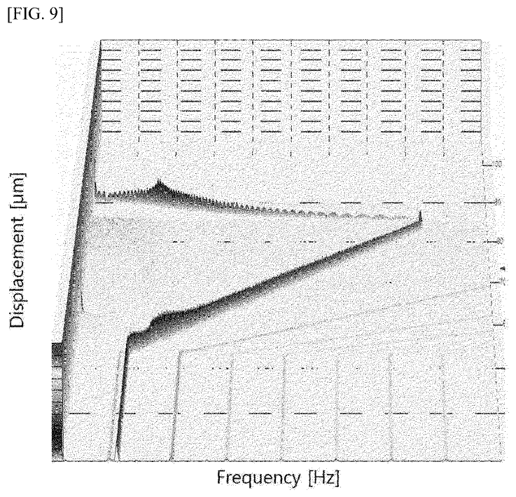

As described above, according to the present invention, the fixing types of the first bump foil key 312A and the second bump foil key 132B inserted into the bump foil key groove 130 are respectively classified into the fixed end and the free end, which may improve the driving performance of the bearing and improve the durability performance against disturbance. FIG. 9 is a waterfall data graph illustrating a bearing operation of the present invention. As illustrated, it can be ascertained that no asynchronous component occurs in the entire frequency region.

Hereinafter, the asymmetric structures of the first bump foil key 312A and the second bump foil key 312B will be described more specifically.

With reference to FIGS. 7 and 8, the first bump foil key 312A is formed to be longer than the second bump foil key 312B, and the first bump foil key 312A has a structure bent at least one or more times. That is, as in the related art, the second bump foil key 312B is formed by bending the other end of the bump foil once. In contrast, the first bump foil key 312A is formed by bending one end of the bump foil 302 once, and the first bump foil key 312A is additionally bent one or more times.

In a more specific embodiment, with reference to FIG. 8, the first bump foil key 312A has a structure in which a vertical portion 312A-V, which is disposed in the radial direction and formed in an ‘L’ shape made by bending a lower end of the first bump foil key 312A in the circumferential direction, and a horizontal portion 312A-P, which extends in the circumferential direction from a lower end of the vertical portion 312A-V, are connected. That is, the first bump foil key 312A is additionally bent once in the circumferential direction. Further, in this case, the vertical portion 312A-V is fixed and tightly attached to the inner wall of the bump foil key groove 130.

In this case, a length 312A-V_L of the vertical portion may be equal to a depth 130_D of the bump foil key groove, and the horizontal portion 312A-P may be configured to be tightly attached to a bottom of the bump foil key groove 130. That is, the first bump foil key 312A may be configured to be tightly attached to the bottom surface and the inner wall at one side of the key groove 130. Further, therefore, a length 312-P_L of the horizontal portion may be equal to or smaller than a width 130_W of the bump foil key groove. This configuration may increase the adhesion of the first bump foil key 312A in the bump foil key groove 130, thereby reducing a stick-slip phenomenon of the bump foil 302.

In this case, the first bump foil key 312A corresponds to an end of a starting side of the bump foil 302 based on the rotation direction of the rotor 400, and the second bump foil key 312B corresponds to an end of an ending side of the bump foil 302 based on the rotation direction of the rotor 400. That is, in the present invention, the first bump foil key 312A positioned at the end from which the bump foil 302 starts is bent in a direction opposite to the rotation direction, and the first bump foil key 312A is fixedly inserted into the bump foil key groove 130, which may increase the fixing force of the first bump foil key 312A.

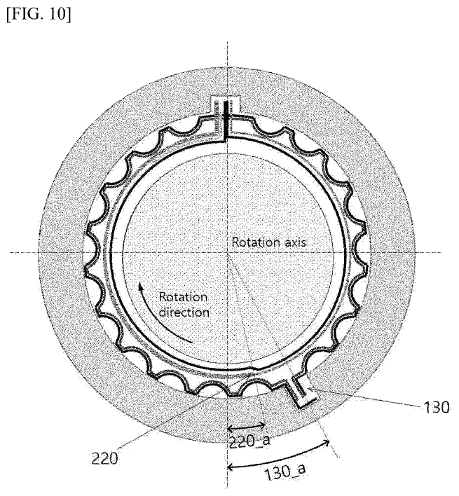

Further, an etching portion 220 (see FIG. 8) may be formed on the mid-foil 202 of the top foil 200 and have a stepped structure formed at a central portion thereof by being changed in thickness or bent. FIG. 10 is a view illustrating FIG. 2 again and illustrating the etching portion 220 of the mid-foil 202. In this case, in the present invention, in order to suppress instability caused by the bumps on the etching portion 220 of the mid-foil 202, the etching portion 220 of the mid-foil 202 is positioned to be biased in the rotation direction with respect to the bump foil key groove 130. That is, as illustrated in FIG. 10, the etching portion 220 of the mid-foil 202 may be disposed inward of the bump foil key groove 130 in the rotation direction. More specifically, an angle 220 a defined between a line connecting a rotation center and the end of the etching portion 220 of the mid-foil 202 and a vertical line passing through the rotation center may be smaller than an angle 130_a defined between a line connecting the rotation center and the center of the bump foil key groove 130 and the vertical line passing through the rotation center. This structure may improve the driving stability of the bearing.

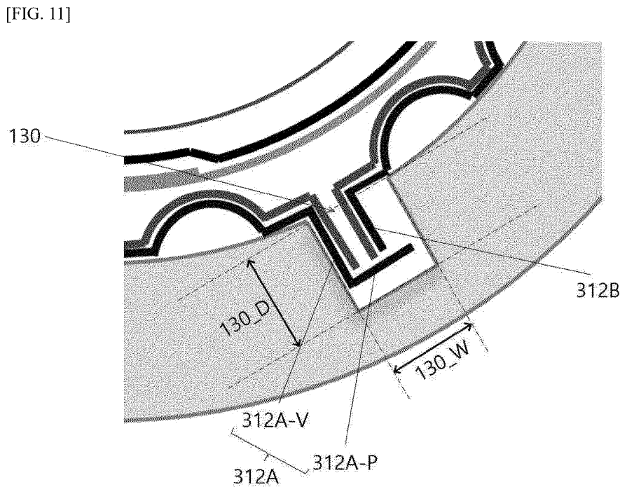

FIGS. 11 to 13 are views illustrating a bump foil structure according to another example of the present invention. Like the previous example, in the present example, the first bump foil key 312A includes the vertical portion 312A-V and the horizontal portion 312A-P. In this case, unlike the previous example, in the present example, a length of the vertical portion 312A-V is smaller than the depth 130_D of the key groove 130, and the horizontal portion 312A-P is disposed to be spaced apart from the bottom of the bump foil key groove 130 at a predetermined interval. That is, in the previous example, the length of the vertical portion 312A-V is equal to the depth 130_D of the key groove 130, such that the vertical portion 312A-V and the horizontal portion 312A-P are tightly attached to the inner wall and the bottom of the key groove 130. On the contrary, in the present example, the vertical portion 312A-V is formed to be short, such that the horizontal portion 312A-P is spaced apart from the bottom of the key groove 130. This configuration has an effect of improving the convenience in assembling the first bump foil key 312A into the bump foil key groove 130.

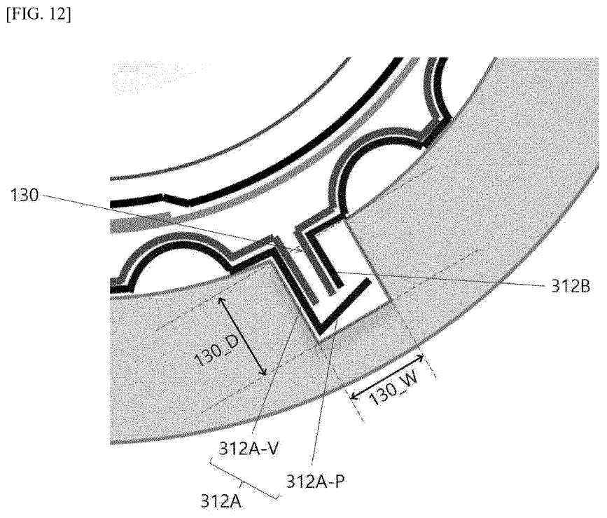

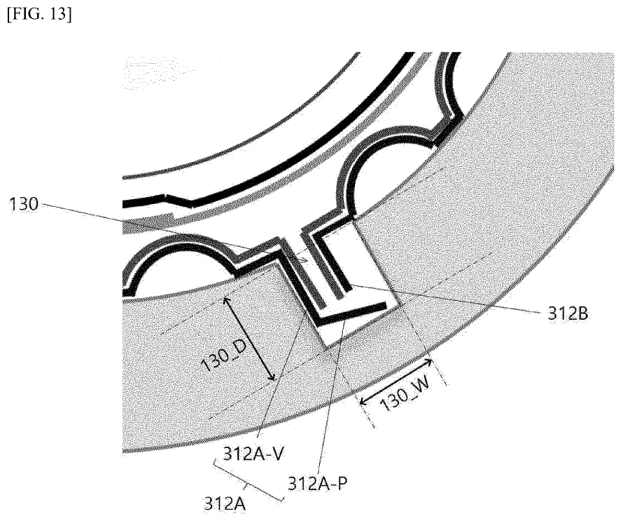

In this case, as illustrated in FIG. 11, an angle between the vertical portion 312A-V and the horizontal portion 312A-P may be a right angle, such that the length 312A-V_L of the horizontal portion 312A-V may be equal to or smaller than the width 130 W of the bottom of the bump foil key groove 130. Alternatively, as illustrated in FIGS. 12 and 13, an angle between the vertical portion 312A-V and the horizontal portion 312A-P may be an obtuse angle or an acute angle, such that the length of the horizontal portion 312A-P may be equal to or larger than the width 130_W of the bottom of the bump foil key groove 130. That is, in the present example, there is a margin for manufacturing and assembly tolerances, which is advantageous in terms of manufacturing and assembly.

As described above, according to the present invention, the bump foil key at one end of the bump foil and the bump foil key at the other end of the bump foil are formed asymmetrically, which may improve driving performance and durability performance against disturbance.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

1000: Airfoil bearing
100: Bearing housing
120: Top foil key groove
130: Bump foil key groove
200: Top foil
201: First top foil (top foil)
202: Second top foil (mid-foil)
220: Etching portion
300: Bump foil
301: First bump foil (upper bump foil)
311: Pair of bump foil keys of first bump foil
302: Second bump foil (lower bump foil)
312: Pair of bump foil keys of second bump foil
312A: First bump foil key
312B: Second bump foil key
400: Rotor

1. An airfoil bearing comprising:
a bearing housing having a cylindrical structure;
a top foil disposed to be spaced apart from an inner side of the bearing housing; and
a bump foil disposed between the bearing housing and the top foil,
wherein in an inner peripheral surface of the bearing housing, a top foil key groove, into which a pair of top foil keys formed by bending two opposite ends of the top foil radially outward are inserted, is formed, and a bump foil key groove, into which a pair of bump foil keys formed by bending two opposite ends of the bump foil radially outward are inserted, is formed, and
wherein when any one of the pair of bump foil keys is referred to as a first bump foil key and the remaining one of the pair of bump foil keys is referred to as a second bump foil key, the first bump foil key and the second bump foil key are formed asymmetrically.

2. The airfoil bearing of claim 1, wherein the first bump foil key is fixed and tightly attached to an inner wall of the bump foil key groove, and
wherein the second bump foil key is disposed to be spaced apart from the inner wall of the bump foil key groove at a predetermined interval.

3. The airfoil bearing of claim 2, wherein the first bump foil key is formed to be longer than the second bump foil key, and
wherein the first bump foil key has a structure bent at least one or more times.

4. The airfoil bearing of claim 3, wherein the first bump foil key comprises a vertical portion arranged in the radial direction, and a horizontal portion extending in the circumferential direction from the lower end of the vertical portion, the structure being formed in an L-shape bent in the circumferential direction, and
wherein the vertical portion is tightly attached to the inner wall of the bump foil key groove.

5. The airfoil bearing of claim 4, wherein a length of the vertical portion is equal to a depth of the bump foil key groove, and
wherein the horizontal portion is configured to be tightly attached to a bottom of the bump foil key groove.

6. The airfoil bearing of claim 5, wherein a length of the horizontal portion is equal to or smaller than a width of the bottom of the bump foil key groove.

7. The airfoil bearing of claim 4, wherein a length of the vertical portion is smaller than a depth of the key groove, and
wherein the horizontal portion is disposed to be spaced apart from a bottom of the bump foil key groove at a predetermined interval.

8. The airfoil bearing of claim 7, wherein an angle between the vertical portion and the horizontal portion is a right angle.

9. The airfoil bearing of claim 8, wherein a length of the horizontal portion is equal to or smaller than a width of the bottom of the bump foil key groove.

10. The airfoil bearing of claim 7, wherein an angle between the vertical portion and the horizontal portion is an obtuse angle or an acute angle.

11. The airfoil bearing of claim 10, wherein a length of the horizontal portion is equal to or larger than a width of the bottom of the bump foil key groove.

12. The airfoil bearing of claim 2, wherein the first bump foil key corresponds to an end of a starting side of the bump foil key based on a rotation direction, and
wherein the second bump foil key corresponds to an end of an ending side of the bump foil key based on the rotation direction.

13. The airfoil bearing of claim 1, wherein when the bump foil has a structure in which two or more bump foil units are stacked and coupled, a bump foil key formed at one end of the bump foil unit positioned at a radially outermost side and a bump foil key formed at the other end of the bump foil unit among the two or more bump foil units are formed asymmetrically.

14. The airfoil bearing of claim 1, wherein an etching portion is formed on the top foil and has a stepped structure formed at a central portion thereof by being changed in thickness or bent, and
wherein the etching portion is positioned inward of the bump foil key groove in a rotation direction.

15. The airfoil bearing of claim 1, wherein the top foil key groove and the bump foil key groove are spaced apart in the circumferential direction.

16. The airfoil bearing of claim 15, wherein a slit is formed in the region where the bump foil overlaps the top foil groove, and
wherein the pair of top foil keys are penetrated through the slit and inserted into the top foil groove.
